(19) United States
(12) Patent Application Publication
(10) Pub. No.: US 2025/0353308 A1
(43) Pub. Date: Nov. 20, 2025

(54) INK PACK

(71) Applicant: CANON KABUSHIKI KAISHA, Tokyo (JP)

(72) Inventor: YUKI KOMORI, Tokyo (JP)

(21) Appl. No.: 19/199,094

(22) Filed: May 5, 2025

(30) Foreign Application Priority Data
May 14, 2024 (JP) 2024-078827

(51) Int. Cl. B41J 2/175

(52) U.S. Cl. CPC B41J 2/17553; B41J 2/17509; B41J 2/17513; B41J 2/17523; B41J 2002/17516

(57) ABSTRACT

An object of the present disclosure is to provide an ink pack that can suppress ink leakage during the injection of ink and has the potential to contribute to the achievement of a sustainable society such as a decarbonized/circular society. An ink pack configured to be able to inject ink into an ink tank included in a liquid discharge apparatus includes: a bag body configured to contain the ink; and an ejection portion extending from an inside to an outside of the bag body to eject the ink. The bag body includes a first gripping portion provided to one side portion of side portions forming an outer periphery, and a second gripping portion provided to a side portion different from the side portion to which the first gripping portion is provided.

### BACKGROUND

### Field of the Disclosure

The present disclosure relates to an ink pack.

### Description of the Related Art

In some cases, an ink tank included in a liquid discharge apparatus (for example, an ink jet printer or the like) is filled with ink by using a filling pouch (an ink pack) containing the ink.

Japanese Patent Laid-Open No. 2018-2262 discloses a filling pouch including a containing bag that contains ink (a bag body), a pouring unit (an ejection unit) that can be engaged with a filling port of an ink tank provided to a liquid discharge apparatus, and a lid member that can be attached to and detached from the pouring unit. According to the filling pouch in Japanese Patent Laid-Open No. 2018-2262, a screw portion is formed in each of the pouring unit and the lid member to be engaged with each other, and the ink flows down the screw portion to be returned into the containing bag in opening and closing the lid member. Therefore, this achieves reduction of the possibility that the vicinity of the pouring unit is contaminated by the ink flowing down an outer periphery surface of the lid member in opening and closing the lid member.

### SUMMARY

The conventional filling pouch has the possibility that the ink overflows and leaks from the filling pouch while injecting the ink depending on handling during the injection of the ink. An object of the present disclosure is to provide an ink pack that can suppress ink leakage during the injection of the ink.

The technique of the present disclosure relates to an ink pack configured to be able to inject ink to an ink tank included in a liquid discharge apparatus: including, a bag body configured to contain the ink; and an ejection portion extending from an inside to an outside of the bag body to eject the ink, wherein the bag body includes a first gripping portion provided to one side portion of side portions forming an outer periphery of the bag body, and a second gripping portion provided to a side portion different from the side portion to which the first gripping portion is provided, wherein, the side portions forming the outer periphery includes a first side portion, a second side portion adjacent to the first side portion, and a third side portion adjacent to the second side portion, the ejection portion is provided to the first side portion, the first gripping portion is provided to the second side portion, and the second gripping portion is provided to the third side portion.

Further features of the present disclosure will become apparent from the following description of exemplary embodiments with reference to the attached drawings.

### BRIEF DESCRIPTION OF THE DRAWINGS

FIG. 1 is a perspective view illustrating an example of a liquid discharge apparatus in an embodiment;

FIG. 2 is a front view illustrating an example of an ink pack in an embodiment;

FIG. 3 is a diagram describing an injection method of ink in an embodiment;

FIG. 4 is a front view illustrating an example of the ink pack in an embodiment;

FIG. 5 is a transparent view illustrating an example of the ink pack in an embodiment that is viewed from the front and above;

FIG. 6 is a front view illustrating an example of the ink pack in an embodiment;

FIG. 7A is a diagram illustrating a state in which a lid is detached from an unused ink pack;

FIG. 7B is a diagram illustrating a state in which a user grips a first gripping portion and a second gripping portion;

FIG. 7C is a diagram illustrating a state in which the ink pack is in an injection posture;

FIG. 8 is a front view illustrating an example of the ink pack in an embodiment;

FIG. 9A is a diagram illustrating a state in which the lid is detached from the unused ink pack;

FIG. 9B is a diagram illustrating a state in which the user rotates the ink pack while gripping the first gripping portion and the second gripping portion;

FIG. 9C is a diagram illustrating a state in which the ink pack is in the injection posture;

FIG. 10 is a front view illustrating an example of the ink pack in an embodiment;

FIG. 11 is a front view illustrating an example of the ink pack in an embodiment;

FIG. 12 is a transparent view illustrating an example of the ink pack in an embodiment that is viewed from the front and above;

FIG. 13 is a front view illustrating an example of the ink pack in an embodiment;

FIG. 14A is a diagram illustrating a step of applying smoothing treatment to the first gripping portion;

FIG. 14B is a diagram illustrating a step of forming a non-slip portion on the first gripping portion; and

FIG. 15 is a schematic front view of the ink pack applicable to a modification of an embodiment.

### DESCRIPTION OF THE EMBODIMENTS

The technologies described in this specification have the potential to contribute to the achievement of a sustainable society, such as a decarbonized society/circular society. In the present disclosure, an ink pack that can suppress ink leakage during the injection of ink and a liquid discharge apparatus are described as a technique that has the potential to contribute to the achievement of a sustainable society.

### First Embodiment

### <Liquid Discharge Apparatus 100>

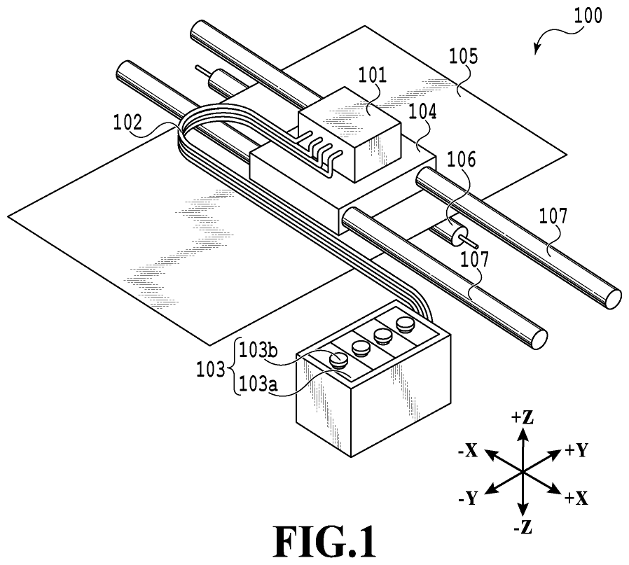

FIG. 1 is a schematic perspective view of a liquid discharge apparatus 100 applicable to the present embodiment.

In the present embodiment, a case where the liquid discharge apparatus 100 is an ink jet printer is assumed and described. However, as long as it is configured to be able to discharge a liquid droplet, an apparatus applicable to the technique of the present disclosure is not limited to the ink jet printer.

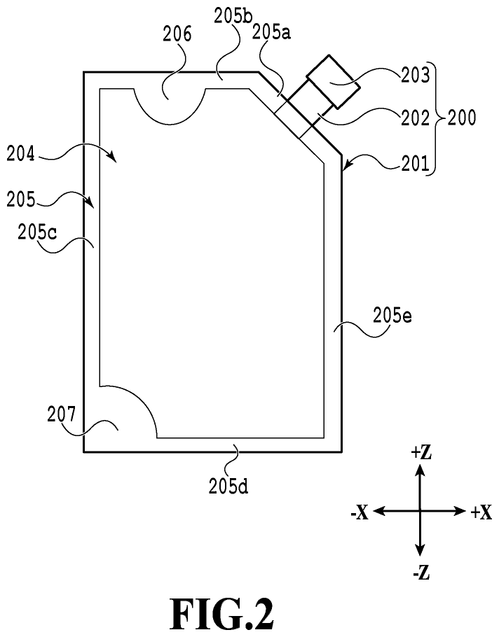

In the present embodiment, an ink pack 200 (see FIG. 2) containing ink that is to be discharged from a discharge head 101 is used as a liquid containing body. For example, four liquid containing bodies contain inks of cyan, magenta, yellow, and black, respectively. Note that, the liquid that can be contained in the liquid containing body of the present disclosure is not limited to those four colors of inks. For example, it is possible to use various liquids including a processing liquid and the like that are used for the purpose of improving fixability of the ink, reducing glossy unevenness, improving scratch resistance, or the like on a printing medium 105.

In the present embodiment, a case where the printing medium 105 is printing paper is assumed and described. However, as long as it is configured to be able to form an image by applying an ink droplet, a medium applicable to the technique of the present disclosure is not limited to the printing paper. An example of the printing medium 105 other than the printing paper includes media having various materials and forms such as a film, cloth, an optical disc label surface, a plastic sheet, an OHP sheet, and an envelope.

In the present disclosure, “printing” means not only forming significant information (for example, such as a character and a graphic that is visible to be visually sensed by a human). Additionally, “printing” also means forming insignificant information. Moreover, in the present disclosure, “printing” widely means forming an image, a design, a pattern, a structure, a combination thereof or the like on the printing medium 105 or processing the medium.

FIG. 1 illustrates arrows X, Y, and Z indicating three directions orthogonal to each other. Note that, the arrows X, Y, and Z are illustrated also in other drawings referred to in the present disclosure as needed so as to correspond to FIG. 1.

A Z direction indicates a direction parallel to a direction of the gravitational force. A +Z direction is an opposite direction of the gravitational force, and a −Z direction is the direction of the gravitational force. The Z direction coincides with a top and bottom direction (a height direction) of the liquid discharge apparatus 100. In the following descriptions, in a case where “top” or “bottom” is mentioned regarding the liquid discharge apparatus 100 and the ink pack 200 (see FIG. 2), unless otherwise stated, it means the top and bottom direction based on the direction of the arrow Z. Specifically, “top” means the +Z direction, and “bottom” means the −Z direction. Additionally, a “horizontal direction” means a direction orthogonal to the Z direction.

A Y direction indicates a conveyance direction of the printing medium 105 in the liquid discharge apparatus 100, which is a direction orthogonal to a width direction (an X direction) of the liquid discharge apparatus 100 at a plane. A +Y direction is a direction from a front surface side toward a back surface side of the liquid discharge apparatus 100. A −Y direction is a direction from the back surface side toward the front surface side of the liquid discharge apparatus 100. The printing medium 105 is conveyed from the back surface side toward the front surface side of the liquid discharge apparatus 100.

The X direction indicates a direction parallel to a right and left direction (the width direction) of the liquid discharge apparatus 100. A −X direction is a direction from a right side toward a left side in a case of facing a front surface of the liquid discharge apparatus 100. A +X direction is a direction from the left side toward the right side in a case of facing the front surface of the liquid discharge apparatus 100. In the following descriptions, in a case where “right” or “left” is mentioned regarding the liquid discharge apparatus 100 and the ink pack 200, unless otherwise stated, it means the right and left direction based on the direction of the arrow X. Specifically, “right” means the +X direction, and “left” means the −X direction.

As illustrated in FIG. 1, the liquid discharge apparatus 100 includes the discharge head 101 that discharges the ink, a tube 102 having flexibility, and an ink tank 103 that reserves the ink. The ink tank 103 includes a reservoir portion 103a that reserves the ink and an injection port 103b from which the ink is injected therein. The liquid discharge apparatus 100 includes a carriage 104 on which the discharge head 101 can be mounted. Note that, as a mode of mounting the discharge head 101 on the carriage 104, a configuration that allows for easy attachment and detachment may be applicable or a configuration of fixed arrangement may be applicable. The liquid discharge apparatus 100 includes a conveyance roller 106 that conveys the printing medium 105 in the conveyance direction (the −Y direction) and two guide rails 107 extending along a scanning direction.

The liquid discharge apparatus 100 repeats reciprocal movement of the discharge head 101 (main scanning) and conveyance of the printing sheet as the printing medium 105 at a predetermined pitch (sub scanning). In synchronization with those movements, multiple types of printing liquids are selectively discharged from the discharge head 101 and applied to the printing medium 105 to form a character, a sign, an image, and so on.

In the present embodiment, a case where the inks of cyan, magenta, yellow, and black are discharged from the discharge head 101 is assumed and described. However, the type of the printing liquid discharged from the discharge head 101 is not limited to those four colors of inks.

The discharge head 101 is mounted on the carriage 104 that is slidably supported by the two guide rails 107 and reciprocally moves on a straight line along the guide rails 107 by a driving unit (for example, a not-illustrated motor or the like). The discharge head 101 includes an energy generation element that generates energy to discharge the ink. An example of the energy generation element includes an electrothermal conversion element (a heater), a piezo element, or the like.

Multiple energy generation elements are arrayed on the discharge head 101. A discharge energy generation element allows an ink discharge unit to discharge the ink supplied from the ink tank 103 via the tube 102. An example of a configuration to discharge the ink includes an example in which a bubble is generated in the ink by heating the heater and this bubble generation energy is utilized to discharge the ink from the discharge head 101.

The printing medium 105 to which the liquid droplet discharged from the discharge head 101 is applied faces a discharge surface (a surface facing the −Z direction) of the discharge head 101 by the conveyance roller 106 and conveyed in a direction crossing a movement direction of the carriage 104. The discharge head 101 includes multiple nozzle arrays to discharge multiple different types of inks.

According to the types of the inks to be discharged from the discharge head 101, the inks are injected to multiple independent ink tanks 103 from the corresponding ink pack 200 (see FIG. 2) containing a predetermined amount of ink in advance.

In the present embodiment, the four ink tanks 103 individually reserve the inks of cyan, magenta, yellow, and black, respectively.

The ink tanks 103 and the discharge head 101 are connected to each other by multiple tubes 102 corresponding to the types of the inks reserved in the corresponding ink tanks 103. It is possible to independently supply corresponding nozzle arrays of the discharge head 101 with the various types of inks reserved in the ink tanks 103 by driving a suction device (for example, a not-illustrated suction pump) included in the liquid discharge apparatus 100. As a matter of course, in this process, the ink may be moved in a flow channel other than the tubes 102.

FIG. 2 is a schematic front view of the ink pack 200 applicable to the present embodiment. Although the arrows X, Y, and Z herein are illustrated under the premise that the ink pack 200 stands on a horizontal plane, it is possible to freely change the orientation of the ink pack 200 that is not connected to the liquid discharge apparatus 100.

As illustrated in FIG. 2, the ink pack 200 includes a bag body 201 that contains the ink and an ejection unit 202 that extends from an inside to an outside of the bag body 201 to eject the ink. In the front view, the bag body 201 includes at least three side portions forming an outer periphery thereof. Note that, in a container portion 204 in the present disclosure, a region including one side extending in a straight line direction and having a width is referred to as a “side portion”. One side portion of the multiple side portions is provided with a first gripping portion 206, and a side portion that is different from the side on which the first gripping portion 206 is provided is provided with a second gripping portion 207.

Specifically, the ink pack 200 includes the bag body 201 having flexibility, the ejection unit 202 (for example, a spout) configured to be able to eject the liquid from the inside to the outside of the bag body 201, and a lid 203 that seals the ejection unit 202. A flow channel to eject the ink from the inside to the outside of the bag body 201 is formed inside the ejection unit 202. A proximal end of the flow channel is positioned inside the bag body 201, and the other end of the flow channel is positioned outside the bag body 201. The lid 203 is detachably attached to the other end of the flow channel. The bag body 201 includes the container portion 204 in which the ink is contained and a non-container portion 205 in which no ink is contained.

In the present embodiment, the bag body 201 is formed by fixing (for example, thermal welding) multiple matching side portions of multiple (for example, two) films to each other. That is, the non-container portion 205 of the present embodiment is a welding portion in which the multiple films are welded to each other. The non-container portion 205 is continuously formed along the outer periphery of the bag body 201.

In the present embodiment, the non-container portion 205 includes a first side portion 205a that is fixed while sandwiching the ejection unit 202 and extends in a direction crossing (in the example in FIG. 2, orthogonal to) a direction in which the ejection unit 202 extends. In the first side portion 205a, the ejection unit 202 is fixed by welding while being sandwiched between the two films. The non-container portion 205 includes a second side portion 205b that is adjacent to the first side portion 205a and extends in a direction crossing the first side portion 205a. The second side portion 205b includes the first gripping portion 206 configured to allow a user to grip.

The first gripping portion 206 is formed such that a width (a size in a direction from the outer periphery of the bag body 201 toward the container portion 204) is greater than a portion formed in a strip shape in the second side portion 205b. In the present embodiment, the first gripping portion 206 is formed in a semicircular shape from the second side portion 205b toward the container portion 204. However, as long as it is a shape that allows the user to grip, the shape of the first gripping portion 206 is not limited to the semicircular shape.

The non-container portion 205 includes a third side portion 205c that is adjacent to the second side portion 205b and extends to cross the second side portion 205b. The third side portion 205c is the longest in the non-container portion 205 of the present embodiment. The third side portion 205c includes the second gripping portion 207 configured to allow the user to grip. The second gripping portion 207 is formed such that a width (a size in a direction from the outer periphery of the bag body 201 toward the container portion 204) is greater than a portion formed in a strip shape in the third side portion 205c.

The non-container portion 205 includes a fourth side portion 205d that is adjacent to the third side portion 205c and extends to cross the third side portion 205c.

In the present embodiment, the second gripping portion 207 is formed in a quadrant shape from a corner portion formed by the third side portion 205c and the fourth side portion 205d toward the container portion 204. However, as long as it is a shape that allows the user to grip, the shape of the second gripping portion 207 is not limited to the quadrant shape.

The non-container portion 205 includes a fifth side portion 205e that extends to connect the fourth side portion 205d and the first side portion 205a to each other.

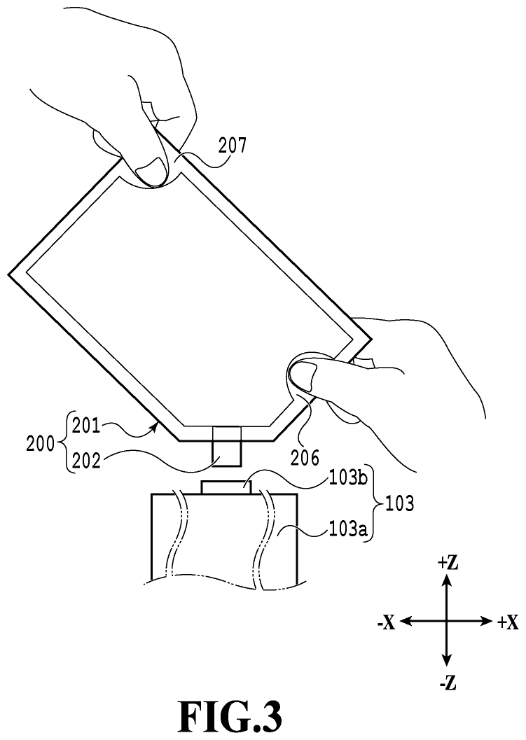

FIG. 3 is a diagram describing an injection method of the ink from the ink pack 200 into the ink tank 103 in the present embodiment.

As illustrated in FIG. 3, the ink pack 200 is configured to be able to inject the ink into the ink tank 103. The ink tank 103 includes the reservoir portion 103a that reserves the ink and the injection port 103b provided on an upper side (a +Z direction side) of the reservoir portion 103a. The ink injected from the injection port 103b is reserved in the reservoir portion 103a.

In a case where the ink is injected into the ink tank 103, the user orients the ejection unit 202 in the direction of the gravitational force while gripping the first gripping portion 206 and the second gripping portion 207. Note that, although both the first gripping portion 206 and second gripping portion 207 are gripped in the present embodiment, only either one of the first gripping portion 206 and the second gripping portion 207 may be gripped. In addition, it is possible to inject the liquid from the ink pack 200 into the ink tank 103 by connecting the ink pack 200 to the ink tank 103 while orienting the ejection unit 202 in the direction of the gravitational force.

In a case where the ink is injected into the ink tank 103, the user detaches the lid 203 (see FIG. 2) of the ink pack 200 from the ejection unit 202.

Inside of the ejection unit 202 is provided with a not-illustrated engagement unit (for example, a slit valve mechanism, a valve spring mechanism, and the like). Until the ejection unit 202 of the ink pack 200 is engaged with the injection port 103b of the ink tank 103, the valve provided to the engagement unit is in a closed state. Accordingly, until the ejection unit 202 is engaged with the injection port 103b, the ink never leaks out of the ejection unit 202 even in a case where the ejection unit 202 is tilted.

With the ejection unit 202 being engaged with the injection port 103b, a valve provided inside the ejection unit 202 transitions to an open state, and the ink is injected from the ink pack 200 into the ink tank 103 by the action of gravity force. In the following descriptions, a posture of the ejection unit 202 facing the direction of the gravitational force (the −Z direction) (a posture of the ink pack 200 illustrated in FIG. 3) is referred to as an “injection posture”.

For example, the user detaches the lid 203 of the ink pack 200 and thereafter rotates the ink pack 200 until the ejection unit 202 is set into the injection posture facing the direction of the gravitational force (the −Z direction) from the posture facing upward (the +Z direction in FIG. 3). In the present disclosure, for example, a direction positioned three o'clock in the rotation direction (the +X direction in FIG. 3) in a case where the ink pack 200 is rotated clockwise to be set into the injection posture is referred to as “frontward”. On the other hand, a direction positioned nine o'clock in the rotation direction (the −X direction in FIG. 3) in a case where the ink pack 200 is rotated clockwise to be set into the injection posture is referred to as “rearward”.

In the injection posture, the first gripping portion 206 is positioned in front of and above the ejection unit 202, and the second gripping portion 207 is positioned behind the ejection unit 202 and above the first gripping portion 206.

With this configuration, in the injection posture, the first gripping portion 206 and the second gripping portion 207 are positioned above the ejection unit 202 from which the ink flows out; for this reason, it is possible to suppress the possibility that the ink is adhered on a finger of the user. In addition, in the injection posture, the first gripping portion 206 and the second gripping portion 207 are positioned in front of and behind the ejection unit 202 in the rotation direction (on a +X direction side and a −X direction side); for this reason, it is possible to stably maintain the injection posture.

Taking into consideration that the user grips the ink pack 200 to carry around, a length of each of the first gripping portion 206 and the second gripping portion 207 along the respective side portions forming the outer periphery of the bag body 201 is preferably 10 cm or smaller.

In the injection posture, taking into consideration that the first gripping portion 206 and the second gripping portion 207 are gripped with fingers of the user, an area of the first gripping portion 206 and an area of the second gripping portion 207 are both preferably 1 cm² or greater.

Taking into consideration the possibility that the ink is adhered on the finger of the user during the injection of the ink, the first gripping portion 206 is preferably arranged in a position 3 cm or more away from the ejection unit 202.

As described above, in the present embodiment, with the user gripping the first gripping portion 206 with one hand and gripping the second gripping portion 207 with the other hand, handleability during the injection of the ink is improved.

In addition, since the first gripping portion 206 and the second gripping portion 207 are gripped by two hands of the user, gripping of the container portion 204 during the injection of the ink is avoided. Accordingly, it is possible to suppress the possibility that the container portion 204 is accidentally squeezed by the user during the injection of the ink and thus a pressure is applied to the inside of the container portion 204, which causes the ink to overflow from the ejection unit 202.

Additionally, in the injection posture of the present embodiment, the first gripping portion 206 and the second gripping portion 207 are positioned above the ejection unit 202. Accordingly, it is possible to suppress contamination of the finger of the user even in a case where the ink overflows from the ejection unit 202 during the injection of the ink.

Moreover, in the injection posture of the present embodiment, the first gripping portion 206 and the second gripping portion 207 are arranged in front of and behind the ejection unit 202, respectively, and are gripped and fixed by the user at the positions. Accordingly, the injection posture becomes stable.

Therefore, according to the ink pack of the present embodiment, it is possible to suppress ink leakage during the injection of the ink.

### Second Embodiment

In the present embodiment, the ink pack in a simpler shape is provided. In the following descriptions, a configuration similar to or corresponding to that of the first embodiment is provided with the same reference numeral while omitting the description, and a different point is mainly described.

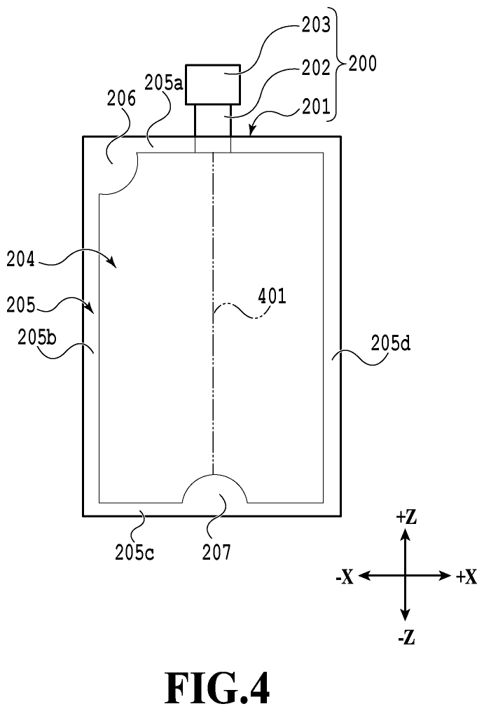

FIG. 4 is a schematic front view of the ink pack 200 applicable to the present embodiment.

As illustrated in FIG. 4, the ink pack 200 of the present embodiment includes four side portions. Specifically, in a state in which the ink pack 200 is viewed from the front, the shape of the bag body 201 is substantially rectangular. The non-container portion 205 of the present embodiment includes the first side portion 205a, the second side portion 205b, the third side portion 205c, and the fourth side portion 205d.

In the present embodiment, the first gripping portion 206 is provided to a corner portion formed by the first side portion 205a and the second side portion 205b. The shape of the first gripping portion 206 in the present embodiment is a quadrant shape. However, the shape of the first gripping portion 206 is not limited to the quadrant shape.

The second gripping portion 207 is provided to the third side portion 205c. In the present embodiment, the second gripping portion 207 is provided in the substantially center of the third side portion 205c. The shape of the second gripping portion 207 in the present embodiment is a semicircular shape. However, the shape of the second gripping portion 207 is not limited to the semicircular shape.

With this configuration too, in the injection posture, the first gripping portion 206 and the second gripping portion 207 are positioned above the ejection unit 202; for this reason, it is possible to suppress the possibility that the ink is adhered on the finger of the user.

Additionally, although the second gripping portion 207 is positioned on a virtual line 401 of the ejection unit 202 extending in a vertical direction in the injection posture of the present embodiment, it is still possible to stably maintain the injection posture even with such arrangement. In the present embodiment, as described above, with the user gripping the first gripping portion 206 with one hand and gripping the second gripping portion 207 with the other hand to maintain the injection posture, the handleability during the injection of the ink is improved.

Therefore, according to the technique of the present embodiment, it is possible to provide an ink pack in a simpler shape.

### Third Embodiment

In the present embodiment, a self-standing ink pack is provided. In the following descriptions, a configuration similar to or corresponding to that of the first and second embodiments is provided with the same reference numeral while omitting the description, and a different point is mainly described.

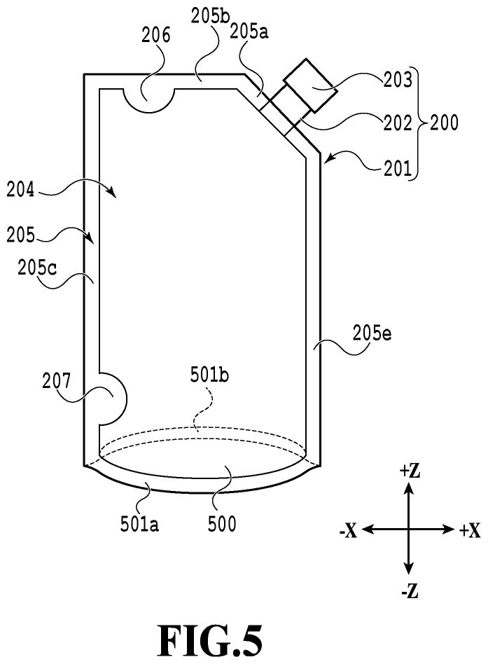

FIG. 5 is a schematic transparent view of the ink pack 200 applicable to the present embodiment that is viewed from the front and above.

As illustrated in FIG. 5, the ink pack 200 of the present embodiment includes a gusset portion 500 positioned at the bottom of the container portion 204 in a standing state. Instead of the fourth side portion 205d (see FIG. 2 and the like), the non-container portion 205 of the present embodiment includes a front side welding portion 501a between the gusset portion 500 and a film on a front surface side and a back side welding portion 501b between the gusset portion 500 and a film on a back surface side. In the present embodiment, the shapes of the first gripping portion 206 and the second gripping portion 207 are semicircular shapes. However, the shapes of the first gripping portion 206 and the second gripping portion 207 are not limited to the semicircular shapes.

With this configuration, it is possible to allow the ink pack 200 to stand by itself, and it is convenient. Additionally, the gusset portion makes it possible to make the inner volume of the container portion 204 greater than that of the first and second embodiments.

With this configuration too, in the injection posture, the first gripping portion 206 and the second gripping portion 207 are positioned above the ejection unit 202. In addition, the second gripping portion 207 is positioned behind the ejection unit 202, and the first gripping portion 206 is positioned in front of the ejection unit 202.

Therefore, according to the technique of the present embodiment, it is possible to provide a self-standing ink pack. In addition, it is also possible to increase the capacity.

### Fourth Embodiment

In the present embodiment, an ink pack that allows for easy recognition of the injection posture is provided. In the following descriptions, a configuration similar to or corresponding to that of the first to third embodiments is provided with the same reference numeral while omitting the description, and a different point is mainly described.

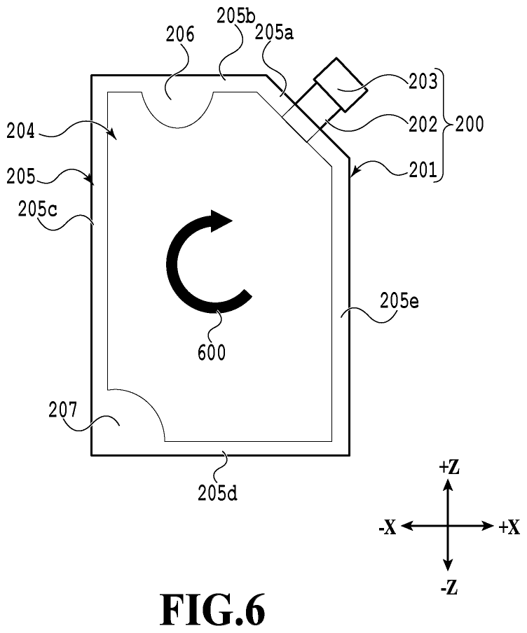

FIG. 6 is a schematic front view of the ink pack 200 applicable to the present embodiment.

As illustrated in FIG. 6, in a state in which the ink pack 200 of the present embodiment is viewed from the front, the container portion 204 includes an arrow 600 that indicates the rotation direction to set the ink pack 200 into the injection posture.

Although the direction of the arrow 600 indicates clockwise in the present embodiment, the rotation direction of the ink pack 200 may be counterclockwise as long as it is possible to set the ink pack 200 into the injection posture during the injection of the ink. That is, the direction of the arrow 600 may be set as needed depending on a positional relationship between the first gripping portion 206, the second gripping portion 207, and the ejection unit 202.

Additionally, although the arrow is displayed in the substantially center of the container portion 204 in the present embodiment, the display position of the arrow is not limited to the substantially center of the container portion 204 as long as it is possible to set the ink pack 200 into the injection posture during the injection of the ink. The arrow 600 may be directly printed on a front surface of the container portion 204, an irregularity portion indicating the arrow 600 may be formed on a surface of the container portion 204, or a label on which the arrow 600 is printed may be affixed to the front surface of the container portion 204. As a matter of course, multiple arrows 600 may be displayed.

Additionally, as long as it is possible to guide the user to set the ink pack 200 into the injection posture, the guide applied to the ink pack 200 may be a guide other than the arrow. For example, a text instructing the user to rotate the ink pack 200 so that the ejection unit 202 faces a weight direction may be displayed.

### <Injection Method of Ink>

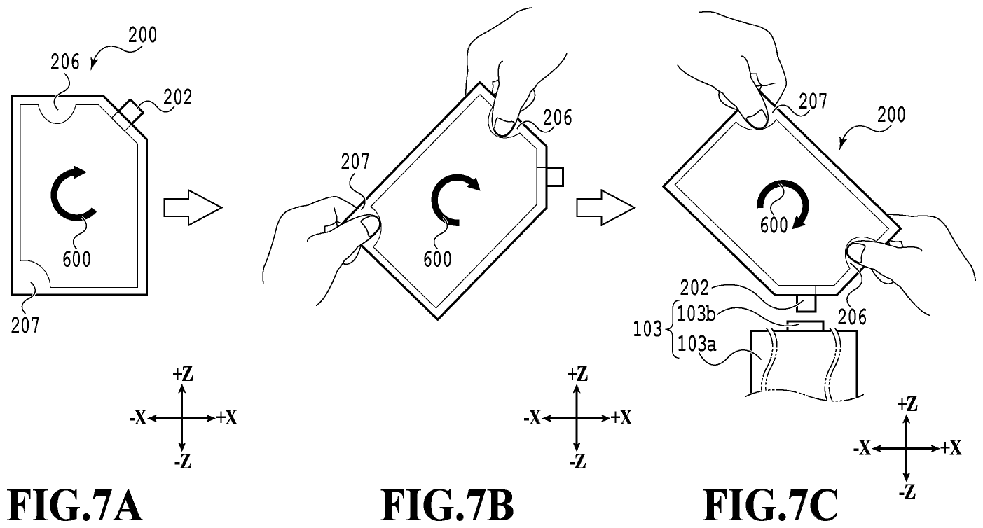

FIGS. 7A to 7C are diagrams describing a procedure of the injection of the ink that is applicable to the present embodiment.

FIG. 7A is a diagram illustrating a state in which the lid 203 (see FIG. 6 and the like) is detached from an unused ink pack 200. As illustrated in FIG. 7A, first, the user detaches the lid 203 from the ejection unit 202. After the lid 203 is detached from the ejection unit 202, the user grips the first gripping portion 206 and the second gripping portion 207.

FIG. 7B is a diagram illustrating a state in which the user grips the first gripping portion 206 and the second gripping portion 207. As illustrated in FIG. 7B, the user grips the first gripping portion 206 and the second gripping portion 207 and lifts the ink pack 200. In addition, the user rotates the ink pack 200 while gripping the first gripping portion 206 and the second gripping portion 207.

FIG. 7C is a diagram illustrating a state in which the ink pack 200 is in the injection posture. As illustrated in FIG. 7C, the user rotates the ink pack 200 along the rotation direction instructed by the arrow 600 and set into the injection posture. Thus, the user engages the injection port 103b with the ejection unit 202 while maintaining the injection posture. Once the ejection unit 202 is engaged with the injection port 103b, the valve of the valve mechanism is opened, and the ink is injected.

With this configuration, it is possible to make the recognition of the rotation direction to set the ink pack 200 into the injection posture easier than that in a configuration without displaying the rotation direction.

Therefore, according to the ink pack of the present embodiment, it is possible to allow for easy recognition of the injection posture. Particularly, in a case where the two gripping portions and the ejection unit are in the positional relationship illustrated in FIG. 6, while the ink pack 200 is being rotated to be set into the injection posture, it is possible to keep the first gripping portion 206 and the second gripping portion 207 behind the ejection unit 202 in the rotation direction as illustrated in FIG. 7. Therefore, even in a case where the ink drops from the ejection unit 202 because of a certain reason, it is possible to suppress the possibility of the contamination of the finger of the user with the ink. However, in the present embodiment, the positions of the two gripping portions and the ejection unit are not limited to the above-described example.

### Fourth Embodiment of Variation

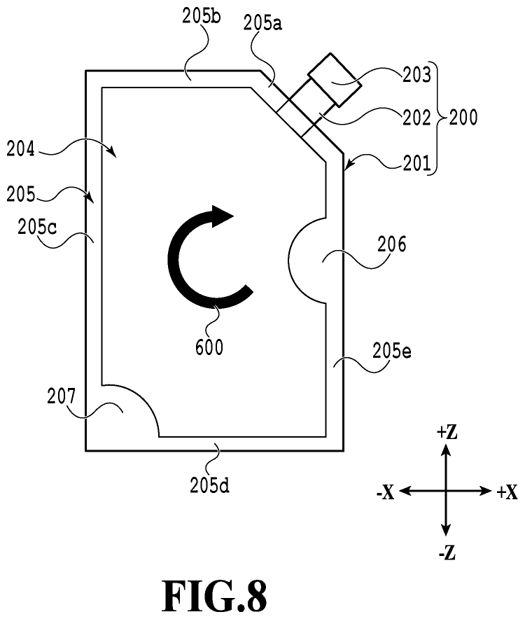

FIG. 8 is a diagram illustrating a modification of the ink pack 200 applicable to the fourth embodiment. As illustrated in FIG. 8, in the present modification, the first gripping portion 206 is provided to the fifth side portion 205e. Other configurations are similar to the examples illustrated in FIGS. 6 and 7A to 7C.

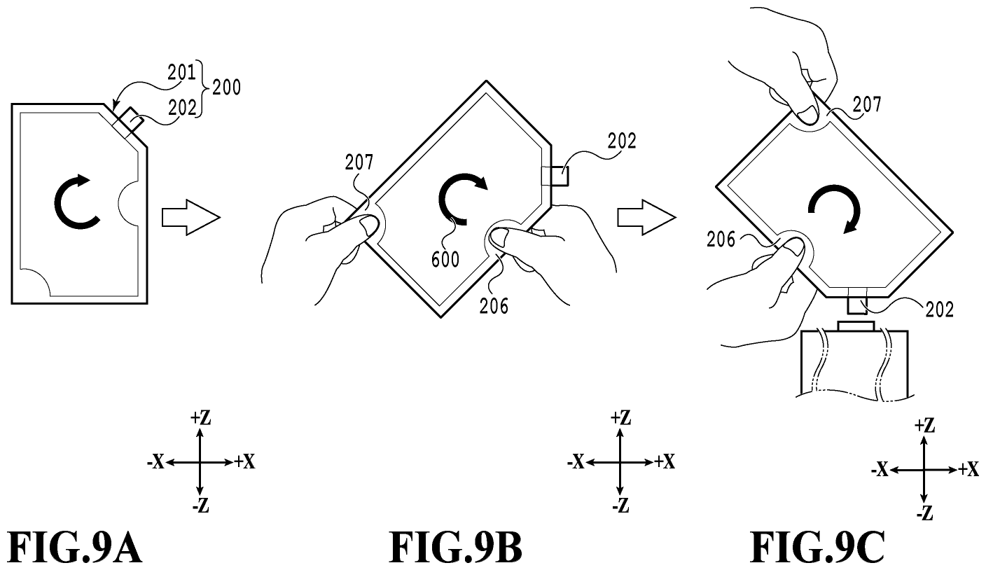

FIGS. 9A to 9C are diagrams describing a procedure of the injection of the ink in the present modification.

FIG. 9A is a diagram illustrating a state in which the lid 203 is detached from the unused ink pack 200. As illustrated in FIG. 9A, first, the user detaches the lid 203 (see FIG. 8) from the ejection unit 202.

FIG. 9B is a diagram illustrating a state in which the user rotates the ink pack 200 while gripping the first gripping portion 206 and the second gripping portion 207.

FIG. 9C is a diagram illustrating a state in which the ink pack 200 is in the injection posture.

In the present modification, as illustrated in FIG. 9B, once the user grips the first gripping portion 206 and rotates the ink pack 200 along the rotation direction instructed by the arrow 600, the finger gripping the first gripping portion 206 is positioned directly below the ejection unit 202. Therefore, there is a higher possibility of the contamination of the finger of the user than that in the configuration in FIG. 6. However, even in such a configuration, the application of the arrow 600 allows the user to join the ink pack to the ink tank in the correct rotation direction and fill the ink tank with the ink.

That is, in the present modification too, it is possible to properly fill the ink tank with the ink while suppressing ink leakage during the injection of the ink.

### Fifth Embodiment

In the present embodiment, an ink pack that can be gripped more easily is provided. In the following descriptions, a configuration similar to or corresponding to that of the first to fourth embodiments is provided with the same reference numeral while omitting the description, and a different point is mainly described.

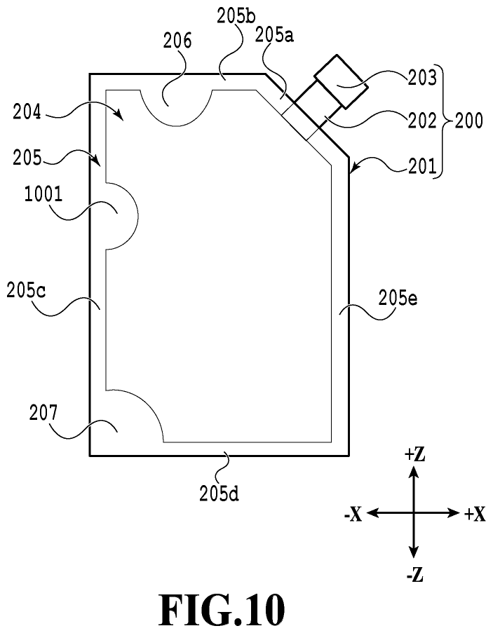

FIG. 10 is a schematic front view of the ink pack 200 applicable to the present embodiment.

As illustrated in FIG. 10, in the present embodiment, a side portion other than the first side portion 205a is additionally provided with a third gripping portion 1001 different from the first gripping portion 206 and the second gripping portion 207. For example, the third side portion 205c is provided with the second gripping portion 207 and the third gripping portion 1001. The third gripping portion 1001 is configured to be able to be gripped by the user. The third gripping portion 1001 is formed such that a width (a size in a direction from the outer periphery of the bag body 201 toward the container portion 204) is formed to be greater than the portion formed in the strip shape in the third side portion 205c.

The third gripping portion 1001 is formed in a semicircular shape from the third side portion 205c toward the container portion 204. However, as long as it is a shape that can be gripped by the user, the shape of the third gripping portion 1001 is not limited to the semicircular shape. Taking into consideration the gripping by the user with the finger, the third gripping portion 1001 preferably has an area of 1 cm² or greater.

The second gripping portion 207 is provided to the corner portion formed by the third side portion 205c and the fourth side portion 205d. The third gripping portion 1001 is provided between a corner portion formed by the second side portion 205b and the third side portion 205c and the second gripping portion 207.

In the present embodiment, during the injection of the ink from the ink pack 200 into the ink tank 103, the user grips the second gripping portion 207 and either one of the first gripping portion 206 and the third gripping portion 1001. Thus, in the injection posture, the first gripping portion 206, the second gripping portion 207, and the third gripping portion 1001 are positioned above the ejection unit 202. Accordingly, even in a case where the user injects the ink while gripping the second gripping portion 207 and the third gripping portion 1001, it is possible to reduce the possibility that the finger of the user is contaminated with the ink.

Additionally, in the injection posture of the present embodiment, the first gripping portion 206 and the third gripping portion 1001 are positioned in front of the ejection unit 202, and the second gripping portion 207 is positioned behind the ejection unit 202. Accordingly, it is possible to improve handleability and make the injection posture stable.

As described above, according to the ink pack in the present embodiment, it is possible to provide more places that can be gripped during the injection of the ink than that in the first to fourth embodiments. Accordingly, during the injection of the ink, it is possible to select the second gripping portion 207 and either one of the first gripping portion 206 and the third gripping portion 1001 to grip, which is convenient.

Therefore, according to the technique of the present embodiment, it is possible to provide an ink pack that can be gripped more easily.

### Sixth Embodiment

In the present embodiment, an ink pack in which the gripping portion is provided to an outer side of the side portion is provided. In the following descriptions, a configuration similar to or corresponding to that of the first to sixth embodiments is provided with the same reference numeral while omitting the description, and a different point is mainly described.

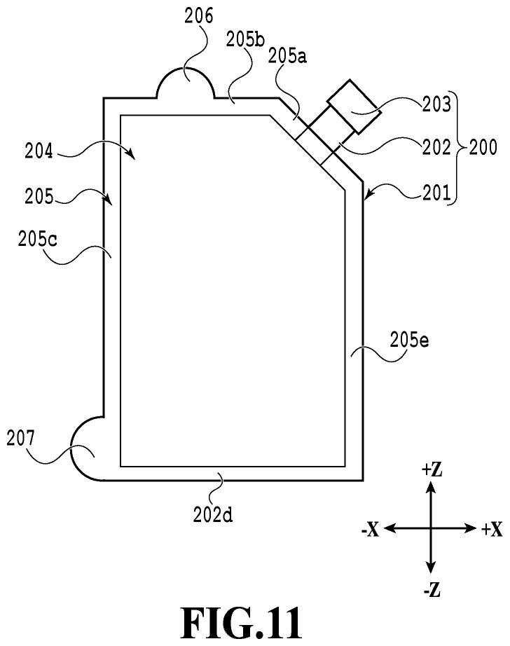

FIG. 11 is a schematic front view of the ink pack 200 applicable to the present embodiment.

As illustrated in FIG. 11, in the present embodiment, the first gripping portion 206 is provided so as to project from the second side portion 205b in a direction away from the container portion 204. The first gripping portion 206 of the present embodiment is provided to a substantially center portion of the second side portion 205b. The second gripping portion 207 is provided so as to project from the third side portion 205c in a direction away from the container portion 204. The second gripping portion 207 of the present embodiment is provided to the corner portion formed by the third side portion 205c and the fourth side portion 205d.

In the present embodiment, the shapes of the first gripping portion 206 and the second gripping portion 207 are semicircular tab shapes provided so as to extend from the inside to the outside of the bag body 201. However, the shapes of the first gripping portion 206 and the second gripping portion 207 are not limited to the semicircular tab shapes.

With this configuration, the first gripping portion 206 and the second gripping portion 207 do not extend from the second side portion 205b and the third side portion 205c toward the container portion 204, respectively. Therefore, in the present embodiment, it is possible to make the capacity of the container portion 204 greater than that in the above-described embodiment.

Therefore, according to the technique of the present embodiment, it is possible to provide an ink pack in which the gripping portion is provided to the outer side of the side portion. In addition, it is also possible to make the capacity of the ink that can be contained greater than that in the first, second, fourth, and fifth embodiments.

### Seventh Embodiment

In the present embodiment, an ink pack that can contain more ink than that in the above-described embodiment is provided. In the following descriptions, a configuration similar to or corresponding to that of the first to sixth embodiments is provided with the same reference numeral while omitting the description, and a different point is mainly described.

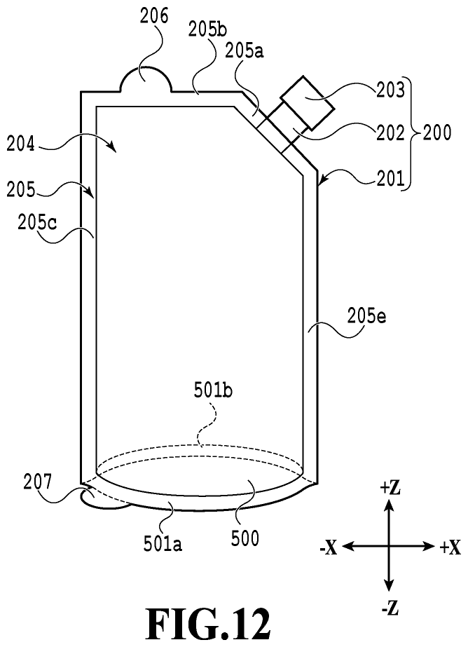

FIG. 12 is a schematic transparent view of the ink pack 200 applicable to the present embodiment that is viewed from the front and above.

As illustrated in FIG. 12, the ink pack 200 of the present embodiment includes the gusset portion 500. With this, it is possible to make a posture other than the injection posture more stable and also make the capacity greater than a configuration not including the gusset portion 500.

In the present embodiment, the first gripping portion 206 is provided so as to project from the second side portion 205b in a direction away from the container portion 204. The first gripping portion 206 of the present embodiment is provided to a substantially center portion of the second side portion 205b.

The second gripping portion 207 is provided so as to project from the front side welding portion 501a in a direction away from the container portion 204. The second gripping portion 207 is provided near a corner portion formed by the front side welding portion 501a and the third side portion 205c.

In the present embodiment, the shapes of the first gripping portion 206 and the second gripping portion 207 are semicircular tab shapes. However, the shapes of the first gripping portion 206 and the second gripping portion 207 are not limited to the semicircular tab shapes.

With this configuration, as with the third embodiment, the gusset portion 500 makes it possible to make the volume of the ink that can be contained greater than that in a configuration not including the gusset portion 500. In addition, as with the seventh embodiment, since the first gripping portion 206 and the second gripping portion 207 do not extend from the second side portion 205b and the third side portion 205c toward the container portion 204, respectively, the capacity of the container portion 204 is not reduced.

Therefore, according to the ink pack of the present embodiment, it is possible to contain more ink.

### Eighth Embodiment

In the present embodiment, an ink pack that can further improve gripping force is provided. In the following descriptions, a configuration similar to or corresponding to that of the first to seventh embodiments is provided with the same reference numeral while omitting the description, and a different point is mainly described.

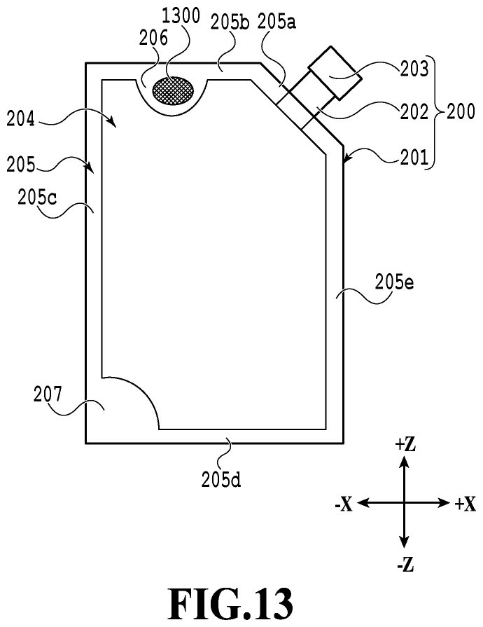

FIG. 13 is a schematic front view of the ink pack 200 applicable to the present embodiment.

As illustrated in FIG. 13, the first gripping portion 206 of the present embodiment includes a non-slip portion 1300 on which non-slip treatment is applied to make the frictional force greater than that on the front surface of the container portion 204. Note that, the non-slip treatment may be applied to the second gripping portion 207 or may be applied to both the first gripping portion 206 and second gripping portion 207.

An example of the non-slip portion 1300 includes a member such as paper, a film, and rubber fixed to the first gripping portion 206. As long as it has the frictional force greater than that on the front surface of the container portion 204, the member fixed to the first gripping portion 206 is not limited to paper, a film, rubber, and the like. These members are attached to the first gripping portion 206 by welding, an adhesive, or the like. That is, each of the first gripping portion 206 and the second gripping portion 207 may be formed such that a thickness (a length extending in a depth direction in FIG. 13) is greater than that in a portion formed in a strip shape in each of the second side portion 205b and the third side portion 205c.

With this configuration, it is possible to improve the gripping force more than a configuration in which a flat and smooth film forming the non-container portion 205 and the container portion 204 is directly gripped.

As the non-slip portion 1300, front surface treatment (for example, irregularity treatment) may be applied to the first gripping portion 206 to form a rough surface with frictional force greater than that on the front surface of the container portion 204.

With this configuration, it is possible to make the frictional force in a case of gripping the first gripping portion 206 greater than that in a configuration not including the non-slip portion. Therefore, it is possible to further improve the gripping force with the ink pack of the present embodiment.

### <Method of Forming Non-Slip Portion 1300>

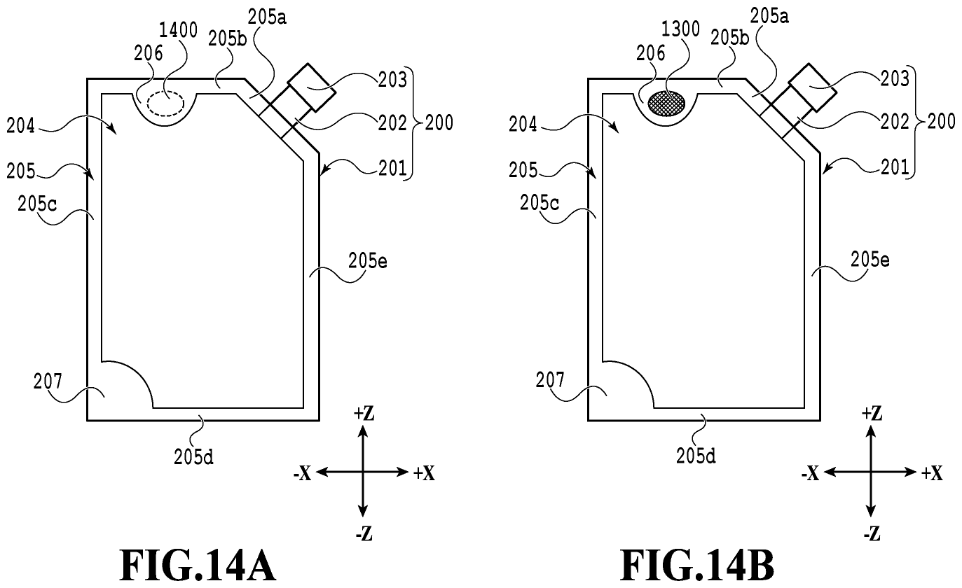

FIGS. 14A and 14B are diagrams describing a method of forming the non-slip portion 1300 applicable to the present embodiment. Hereinafter, a case where rubber is welded on the first gripping portion 206 as the non-slip portion 1300 is assumed and described.

FIG. 14A is a diagram illustrating a step of applying smoothing treatment to the first gripping portion 206.

FIG. 14A illustrates an ink pack before the non-slip portion 1300 is formed. The smoothing treatment is applied to a planned portion 1400 on which the non-slip treatment is to be performed. In some cases, the planned portion 1400 has irregularities or is contaminated. In a case where the welding is performed under such circumstances, it is difficult to obtain excellent welding property. Therefore, in the present embodiment, the smoothing treatment is applied to the planned portion 1400 so as to be able to weld the rubber functioning as the non-slip portion 1300 more solidly. With this, it is possible to weld the rubber onto the planned portion 1400 more solidly than a case where the rubber is welded onto the planned portion 1400 without applying the smoothing treatment.

FIG. 14B is a diagram illustrating a step of forming the non-slip portion 1300 on the first gripping portion 206.

As illustrated in FIG. 14B, the rubber functioning as the non-slip portion 1300 is welded onto a portion to which the planned portion 1400 (see FIG. 14A) is applied. With this method, it is possible to weld the rubber onto a smoother front surface.

Therefore, according to the method of forming the non-slip portion in the present embodiment, it is possible to form the non-slip portion more solidly in the first gripping portion.

### Eighth Embodiment of Variation

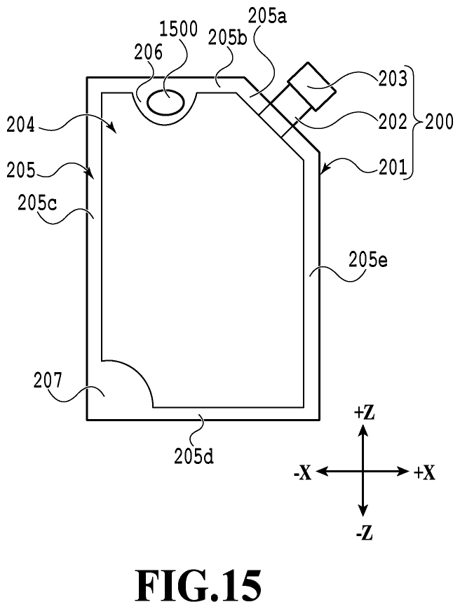

FIG. 15 is a schematic front view of the ink pack 200 applicable to the present modification.

As illustrated in FIG. 15, the first gripping portion 206 in the present modification includes one or more through-holes penetrating through the first gripping portion 206 in a depth direction in FIG. 15. With this configuration, once the user grips the first gripping portion 206, the finger (for example, a first finger) and the finger (for example, a second finger) of the user touch each other directly through the through-hole. Accordingly, with this configuration too, it is possible to improve the gripping force. Note that, the through-hole may be formed in the second gripping portion 207 or may be formed in both the first gripping portion 206 and second gripping portion 207.

### Other Embodiments

Although two or three gripping portions are formed in the above-described embodiment, four or more gripping portions may be formed.

The liquid discharge apparatus to which the technique of the present disclosure is applicable is not limited to a serial scanning type ink jet printer. For example, it is also possible to apply the technique of the present disclosure to a so-called full-line type ink jet printer that has a length in the width direction orthogonal to the conveyance direction and applies the ink droplet to the printing medium without scanning.

According to the ink pack of the present disclosure, it is possible to suppress ink leakage during the injection of the ink.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-078827, filed May 14, 2024, which is hereby incorporated by reference wherein in its entirety.

What is claimed is:

1. An ink pack configured to be able to inject ink to an ink tank included in a liquid discharge apparatus, comprising:
a bag body configured to contain the ink; and
an ejection portion extending from an inside to an outside of the bag body to eject the ink, wherein
the bag body includes
a first gripping portion provided to one side portion of side portions forming an outer periphery of the bag body, and
a second gripping portion provided to a side portion different from the side portion to which the first gripping portion is provided, wherein,
the side portions forming the outer periphery includes a first side portion, a second side portion adjacent to the first side portion, and a third side portion adjacent to the second side portion,
the ejection portion is provided to the first side portion,
the first gripping portion is provided to the second side portion, and
the second gripping portion is provided to the third side portion.

2. The ink pack according to claim 1, wherein
the bag body is formed of a plurality of films, and includes a non-container portion in which the plurality of films are fixed to each other along side portions thereof and no ink is contained, and
the first gripping portion and the second gripping portion are provided to the non-container portion.

3. The ink pack according to claim 2, wherein
the first gripping portion is a portion in which a width is greater than another portion of the non-container portion formed along the first side portion, and
the second gripping portion is a portion in which a width is greater than another portion of the non-container portion formed along the second side portion.

4. The ink pack according to claim 1, wherein
the ink pack is rotated into an injection posture to inject the ink into the ink tank from a posture in which the ejection portion faces upward, and
in the injection posture, the first gripping portion and the second gripping portion are positioned above the ejection portion.

5. The ink pack according to claim 4, wherein
in the injection posture,
the first gripping portion is positioned in front of the ejection portion in the rotation, and
the second gripping portion is positioned behind the ejection portion in the rotation.

6. The ink pack according to claim 1, wherein
the ejection portion includes a valve mechanism, and
the valve of the valve mechanism is in a state to close the ejection portion while the ejection portion is not engaged with the ink tank and is in a state to open the ejection portion while the ejection portion is engaged with the ink tank.

7. The ink pack according to claim 1, wherein
the bag body is formed by thermally-welding a plurality of side portions included in a plurality of films to each other.

8. The ink pack according to claim 1, wherein
the bag body includes a gusset portion.

9. The ink pack according to claim 1, wherein
the bag body indicates a rotation direction to rotate the bag body so as to inject the ink into the ink tank.

10. The ink pack according to claim 1, wherein
a side portion other than the first side portion is further provided with a third gripping portion different from the second gripping portion.

11. The ink pack according to claim 1, wherein
the first gripping portion and the second gripping portion are provided so as to extend from the inside to the outside of the bag body.

12. The ink pack according to claim 1, wherein
the first gripping portion, the second gripping portion, or the both include a non-slip portion.

13. The ink pack according to claim 12, wherein
the non-slip portion is a portion to which a member having greater frictional force than that of a front surface of the bag body.

14. The ink pack according to claim 12, wherein
the non-slip portion is a portion to which irregularity treatment is applied to make the frictional force greater than that of the front surface of the bag body.

15. The ink pack according to claim 1, wherein
the first gripping portion, the second gripping portion, or the both have a through-hole.

16. The ink pack according to claim 1, wherein
the first gripping portion is arranged in a position 3 cm or more away from the ejection portion.

17. The ink pack according to claim 1, wherein
the first gripping portion and the second gripping portion have an area of 1 cm² or greater.

18. The ink pack according to claim 10, wherein
the third gripping portion has an area of 1 cm² or greater.

19. The ink pack according to claim 1, wherein
a length of each of the first gripping portion and the second gripping portion along the plurality of the side portions is 10 cm or smaller.
